(19) United States
(12) Patent Application Publication
(10) Pub. No.: US 2018/0285827 A1
(43) Pub. Date: Oct. 4, 2018

(54) DISTINGUISHING EVENTS OF USERS FOR EFFICIENT SERVICE CONTENT DISTRIBUTION

(71) Applicant: MICROSOFT TECHNOLOGY LICENSING, LLC, REDMOND, WA (US)

(72) Inventors: DIKLA DOTAN-COHEN, HERZELIA (IL); HAIM SOMECH, HERZELIA (IL); IDO PRINESS, HERZELIA (IL)

(21) Appl. No.: 15/472,117

(22) Filed: Mar. 28, 2017

(51) Int. Cl. G06Q 10/10; G06F 9/54

(52) U.S. Cl. CPC G06Q 10/1095; G06F 9/542

(57) ABSTRACT

In some implementations, a user schedule is constructed comprising planned events of a user. It is determined that a planned event of the planned events corresponds to a divergence from a pattern of detected instances of a routine of the user based on user activity data from a set of sensors. An occurrence of an event of the user is determined from the user activity data. It is determined the divergence failed to occur based on the occurrence of the event and the user schedule. Based on the determining the divergence failed to occur, content associated with the routine is caused to be presented on a user device.

### BACKGROUND

It has been said that humans are creatures of habit. Accordingly, many devices are designed to be adaptable or customizable to accommodate habitual behavior, or routines, of users. For example, many cellular telephones and home telephones permit a user to program speed dial numbers into them, allowing the user to dial the speed dial numbers by pressing only one key or button, rather than having to dial the entire telephone number. Likewise, many computer programs allow the user to customize graphical user interfaces (GUIs) in order to make tools or features that are commonly used more readily accessible. While these devices are most useful when a user engages in his habitual behavior, their utility is compromised when the user departs from his routine. For example, a user may become accustomed to features that assist or are otherwise tailored to his habitual behavior but are unavailable when acting out of routine. However, oftentimes, assistance would be most helpful when a user has diverged from, is diverging from, or plans to diverge from his routines. In order to efficiently and accurately utilize computing resources to prepare, generate, and provide content to users, a computing system should be capable of interpreting user context.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Aspects of the present disclosure relate to distinguishing events of users for efficient service content distribution. In doing so, content can be prepared, generated, and/or provided to users in a computationally efficient and accurate manner. For example, some content may be prepared in advance (e.g., for time-sensitive provision of content) and/or withheld when erroneous or irrelevant.

An event can correspond to a defined user action or grouping of user actions, which may be under defined conditions, such as a time of day, a day of the week, a location, or other computer detectable behavior associated with a user, such as actions associated with geographic locations, semantics of locations, persons the user is with, weather conditions, and more. A user routine, or a routine of a user, can correspond to recurring actions, behavior patterns (e.g., patterns of events), or other habitual computer detectable behavior of a user, such as workout habits of the user, the user's routine of commuting to work, and many more. In this respect, a routine may be defined in terms of one or more events that make up the routine.

In certain respects, the present disclosure provides computer technologies for the detection and tracking of instances of events with respect to users. The events can be analyzed with respect to one or more routines. For example, a routine may be identified as corresponding to a user based on patterns formed by detected events (e.g., the user drives to work around 1 PM during weekdays), corresponding to the user, that make up the routine.

In further respects, the present disclosure provides computer technologies for distinguishing between types of events of users. Some events may be identified and/or designated as planned events based on detecting planning activity in user activity data, such as a calendar item, search activity, user communications, or other data associated with planning the events. Other events may be identified and/or designated as unplanned events based on failing to detect the planning activity for the events.

In additional aspects of the present disclosure, some events may be identified and/or designated as routine events, or events which are determined to be part of a routine associated with a user. Other events may be identified and/or designated as out of routine events, or events which diverge from one or more routines of a user. An out of routine event may be identified based on determining the event fails to conform with one or more events that make up a routine of the user. This may include determining the event indicates the user will fail to practice one or more expected routine events of a routine associated with the user.

In further aspects of the present disclosure, a user schedule may be constructed, which includes the planned events of a user determined from user activity data. The user schedule may include predicted routine events (whether planned or unplanned) and predicted out of routine events. When occurrence of an event is detected (e.g., the system determines the event occurred, is occurring, or will occur), the user schedule can be used to determine whether the event is unplanned based on whether the event is present in the user schedule and/or indicated as being planned by the user schedule. Further, in some cases, the user schedule may indicate whether events are routine events and/or out of routine events. Amongst other capabilities, the user schedule can be used by the system to determine whether a planned out of routine event failed to occur. In this case, the system may refrain from preparing, generating, and/or providing content associated with the planned out of routine event or a routine. Instead, content associated with the routine may be provided to the user.

### BRIEF DESCRIPTION OF THE DRAWINGS

The present invention is described in detail below with reference to the attached drawing figures, wherein:

FIG. 1 is a block diagram showing a system for tailoring content to out of routine events in accordance with implementations of the present disclosure;

FIG. 2 is a block diagram showing an exemplary routine management system in accordance with implementations of the present disclosure;

FIG. 3 illustrates an exemplary content in accordance with implementations of the present disclosure;

FIG. 4 is a flow diagram showing a method for tailoring content to out of routine events in accordance with implementations of the present disclosure;

FIG. 5 is a flow diagram showing a method for distinguishing events of users in accordance with implementations of the present disclosure;

FIG. 6 is a flow diagram showing a method for distinguishing events of users in accordance with implementations of the present disclosure;

FIG. 7 is a flow diagram showing a method for distinguishing events of users in accordance with implementations of the present disclosure; and

FIG. 8 is a block diagram of an exemplary computing environment suitable for use in implementations of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present disclosure relate to distinguishing events of users for efficient service content distribution. In doing so, content can be prepared, generated, and/or provided to users in a computationally efficient and accurate manner. For example, some content may be prepared in advance (e.g., for time-sensitive provision of content) and/or withheld when erroneous or irrelevant.

An event can correspond to a defined user action or grouping of user actions, which may be under defined conditions, such as a time of day, a day of the week, a location, or other computer detectable behavior associated with a user, such as actions associated with geographic locations, semantics of locations, persons the user is with, weather conditions, and more. A user routine, or a routine of a user, can correspond to recurring actions, behavior patterns (e.g., patterns of events), or other habitual computer detectable behavior of a user, such as workout habits of the user, the user's routine of commuting to work, and many more. In this respect, a routine may be defined in terms of one or more events that make up the routine.

In certain respects, the present disclosure provides computer technologies for the detection and tracking of instances of events with respect to users. The events can be analyzed with respect to one or more routines. For example, a routine may be identified as corresponding to a user based on patterns formed by detected events (e.g., the user drives to work around 1 PM during weekdays), corresponding to the user, that make up the routine.

In further respects, the present disclosure provides computer technologies for distinguishing between types of events of users. Some events may be identified and/or designated as planned events based on detecting planning activity in user activity data, such as a calendar item, search activity, user communications, or other data associated with planning the events. Other events may be identified and/or designated as unplanned events based on failing to detect the planning activity for the events.

In additional aspects of the present disclosure, some events may be identified and/or designated as routine events, or events which are determined to be part of a routine associated with a user. Other events may be identified and/or designated as out of routine events, or events which diverge from one or more routines of a user. An out of routine event may be identified based on determining the event fails to conform with one or more events that make up a routine of the user. This may include determining the event indicates the user will fail to practice one or more expected routine events of a routine associated with the user.

In further aspects of the present disclosure, a user schedule may be constructed, which includes the planned events of a user determined from user activity data. The user schedule may include predicted routine events (whether planned or unplanned) and predicted out of routine events. When occurrence of an event is detected (e.g., the system determines the event occurred, is occurring, or will occur), the user schedule can be used to determine whether the event is unplanned based on whether the event is present in the user schedule and/or indicated as being planned by the user schedule. Further, in some cases, the user schedule may indicate whether events are routine events and/or out of routine events. Amongst other capabilities, the user schedule can be used by the system to determine whether a planned out of routine event failed to occur. In this case, the system may refrain from preparing, generating, and/or providing content associated with the planned out of routine event or a routine. Instead, content associated with the routine may be provided to the user.

Optionally, the user schedule may include one or more routine events that are predicted not to occur based on detecting one or more out of routine events. Based on detecting a routine event predicted to not occur based on an out of routine event, the system may determine the out of routine event failed to occur. As another example, based on determining the out of routine event failed to occur, the system may determine the routine event that was predicted to not occur will occur. In response to either of these determinations, the system may refrain from providing content associated with the out of routine event to a user device and may instead provide content associated with the routine event.

Using approaches described herein for distinguishing between events, content, such as service content, can be prepared, generated, and/or provided in association with events in a computationally efficient and accurate manner. Further, at least some of this functionality can be performed in advance of detection of corresponding events, allowing for rapid conveyance of time-sensitive information to users.

In certain respects, routines and events may be analyzed based on accumulated user data that can indicate the occurrence of one or more instances of events of the routines and/or divergences from the routines. Accumulated user data can comprise a collection of data that corresponds to a user. The user data may be continuously collected over time by a large variety of possible data sources and/or data systems that on aggregate form a detailed record of patterns of user actions that correspond to one or more routines of the user. These routines and events of the user can be identified, extracted, and/or analyzed from the accumulated user data at a level of scope, accuracy, and quantity that otherwise would not be achievable by the user alone.

It is intended that the accumulation of user data embody robust privacy and data protection for individuals, businesses, and public-sector organizations. In this respect, users are given control over many aspects related to the user data, including the ability to opt in or opt out of data collection and/or any of the various tracking or analysis features described herein. Furthermore, safeguards are to be implemented to protect sensitive user data from access by other parties, including other users, without express consent of the user. Additionally, any user data is intended to be made anonymous, when possible.

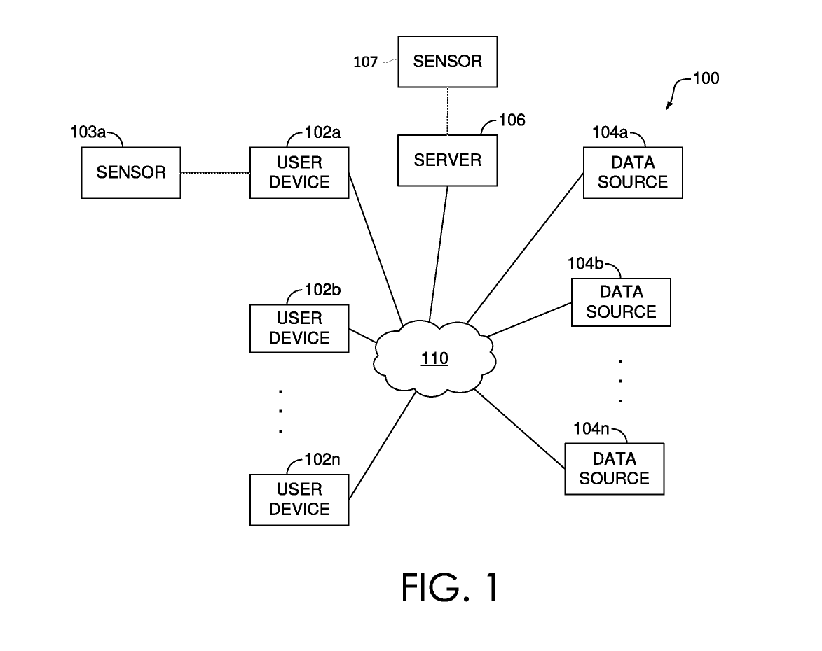

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

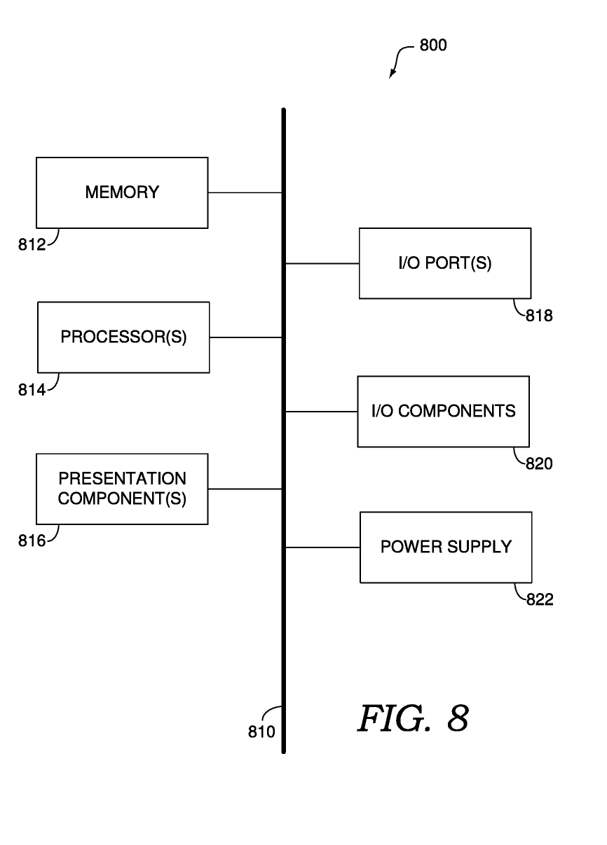

Among other components not shown, example operating environment 100 includes a number of user devices, such as user devices 102a and 102b through 102n; a number of data sources, such as data sources 104a and 104b through 104n; server 106; sensors 103a and 107; and network 110. It should be understood that operating environment 100 shown in FIG. 1 is an example of one suitable operating environment. Each of the components shown in FIG. 1 may be implemented via any type of computing device, such as computing device 800, described in connection to FIG. 8, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

It should be understood that any number of user devices, servers, and data sources may be employed within operating environment 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n may comprise any type of computing device capable of use by a user. For example, in one embodiment, user devices 102a through 102n may be the type of computing device described in relation to FIG. 8 herein. By way of example and not limitation, a user device may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, a camera, remote control, a bar code scanner, a computerized measuring device, appliance, consumer electronic device, a workstation, or any combination of these delineated devices, or any other suitable device.

User devices 102a and 102b through 102n can be client devices on the client-side of operating environment 100, while server 106 can be on the server-side of operating environment 100. Server 106 can comprise server-side software designed to work in conjunction with client-side software on user devices 102a and 102b through 102n so as to implement any combination of the features and functionalities discussed in the present disclosure. This division of operating environment 100 is provided to illustrate one example of a suitable environment, and there is no requirement for each implementation that any combination of server 106 and user devices 102a and 102b through 102n remain as separate entities.

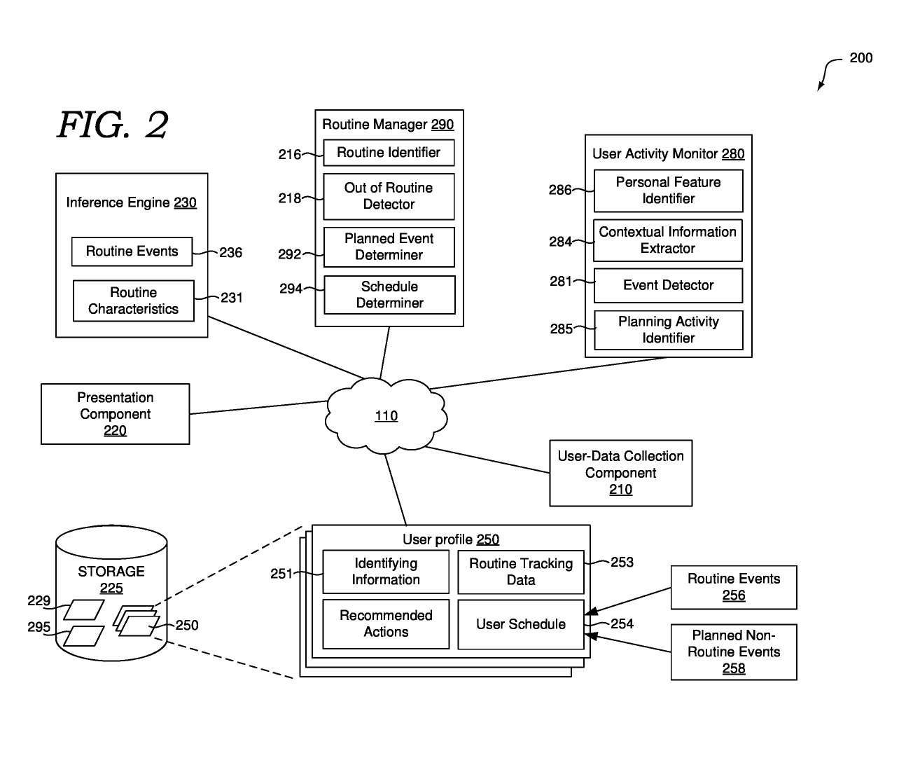

Data sources 104a and 104b through 104n may comprise data sources and/or data systems, which are configured to make data available to any of the various constituents of operating environment 100, or routine management system 200 described in connection to FIG. 2. For instance, in one embodiment, one or more data sources 104a through 104n provide (or make available for accessing) data to user-data collection component 210 of FIG. 2. Data sources 104a and 104b through 104n may be discrete from user devices 102a and 102b through 102n and server 106 or may be incorporated and/or integrated into at least one of those components. In one embodiment, one or more of data sources 104a though 104n comprises one or more sensors, which may be integrated into or associated with one or more of the user device(s) 102a, 102b, or 102n or server 106. Examples of sensed project data made available by data sources 104a though 104n are described further in connection to user-data collection component 210 of FIG. 2.

Operating environment 100 can be utilized to implement one or more of the components of routine management system 200, described in FIG. 2, including components for collecting user data, inferring routines and routine patterns, generating routine models, generating event details or features, and/or presenting routine related content to users. Referring now to FIG. 2, with FIG. 1, a block diagram is provided showing aspects of an example computing system architecture suitable for implementing an embodiment of the invention and designated generally as routine management system 200. Routine management system 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

System 100 can be utilized to implement a routine management system in which routines may be identified, tracked, and analyzed with respect to a plurality of users. Referring now to FIG. 2, FIG. 2 illustrates exemplary routine management system 200, in accordance with implementations of the present disclosure.

Example of a Routine Management System

FIG. 2 provides a block diagram illustrating an exemplary routine management system 200 in which some embodiments of the present disclosure may be employed. In particular, routine management system 200 is one example of a system capable of determining routines from user data, identifying and extracting events from user data, associating events with routines, detecting and identifying out of routine events, constructing user schedules, and detecting and identifying unplanned and planned out of routine events.

Routine management system 200 includes network 110, which is described in connection to FIG. 1, and which communicatively couples components of routine management system 200, including user-data collection component 210, presentation component 220, storage 225, inference engine 230, routine manager 290, user profile(s) 250, user activity monitor 280, and routine manager 290. The components of routine management system 200 may be embodied as a set of compiled computer instructions or functions, program modules, computer software services, or an arrangement of processes carried out on one or more computer systems, such as computing device 800 described in connection to FIG. 8, for example.

In one embodiment, the functions performed by components of routine management system 200 are associated with one or more personal assistant applications, services, or routines. In particular, such applications, services, or routines may operate on one or more user devices (such as user device 104a), servers (such as server 106), may be distributed across one or more user devices and servers, or be implemented in the cloud. Moreover, in some embodiments these components of routine management system 200 may be distributed across a network, including one or more servers (such as server 106) and client devices (such as user device 102a), in the cloud, or may reside on a user device such as user device 102a. Moreover, these components, functions performed by these components, or services carried out by these components may be implemented at appropriate abstraction layer(s) such as the operating system layer, application layer, hardware layer, etc., of the computing system(s).

Alternatively, or in addition, the functionality of these components and/or the embodiments of the invention described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example routine management system 200, it is contemplated that in some embodiments functionality of these components can be shared or distributed across other components.

As noted above, it should be understood that routine management system 200 shown in FIG. 2 is an example of one system in which embodiments of the present invention may be employed. Each component shown may include one or more computing devices similar to the operating environment 100 described with reference to FIG. 1. Routine management system 200 should not be interpreted as having any dependency or requirement related to any single module/component or combination of modules/components illustrated therein. Each may comprise a single device or multiple devices cooperating in a distributed environment. For instance, routine management system 200 may comprise multiple devices arranged in a distributed environment that collectively provide any of the various functionality described herein. Additionally, other components not shown may also be included within the environment. It should therefore be understood that routine management system 200 and/or its various components may be embodied by any suitable computer arrangement in accordance with various embodiments of the present disclosure.

Routine management system 200 generally operates to manage routines with respect to users. This can include identifying routines from user activity data, determining events associated with routines, tracking routines, and correlating events with routines. In some respects, an event can be identified using routine characteristics, formed by patterns extracted from user data (e.g., patterns of events associated with the routine), and determined from routine models. In further respects, correlating an event with a routine can be based on analyzing the similarity between routine characteristics and event characteristics identified from user data.

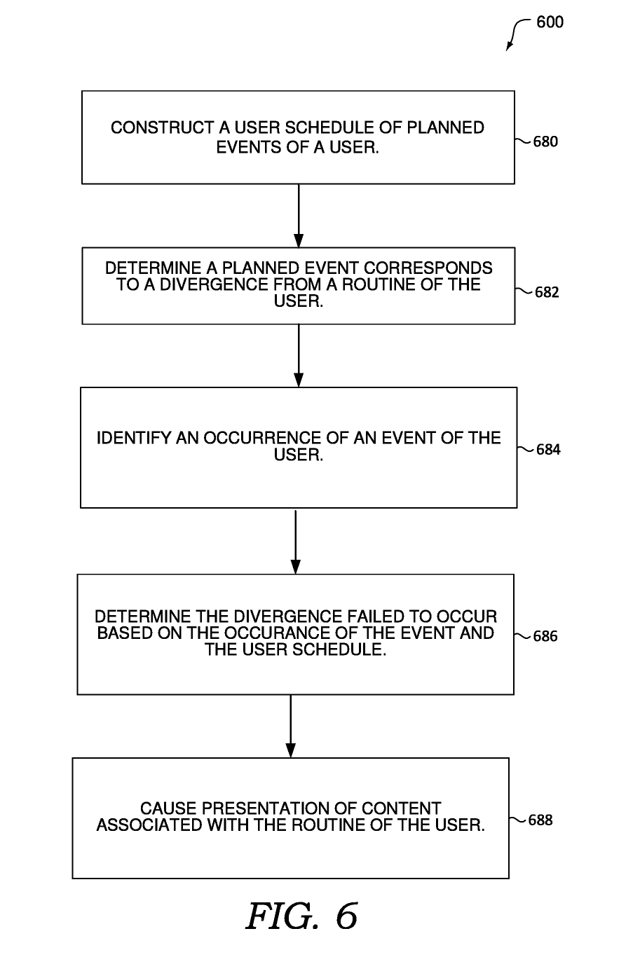

As briefly mentioned above, each component of routine management system 200, including user-data collection component 210, presentation component 220, inference engine 230, routine manager 290, user profile 250, and user activity monitor 280, and their respective subcomponents, may reside on a computing device (or devices). For example, the components of routine management system 200 may reside on the exemplary computing device 800 described below and shown in FIG. 8, or similar devices. Accordingly, each component of the routine management system 200 may be implemented using one or more of a memory, a processors or processors, presentation components, input/output (I/O) ports and/or components, radio(s) and a power supply (e.g., as represented by reference numerals 612-624, respectively, in FIG. 6).

As an overview, in some embodiments, user-data collection component 210 facilitates the intake of data and makes the data available to routine management system 200 in association with users (i.e., user data). User activity monitor 280 analyzes the user data in conjunction with routine manager 290 and inference engine 230 to identify events and routines, extract contextual features associated with user data, and extract personal features of users, such as characteristic features of users.

Inference engine 230 can be used by any of the various components of routine management system 200 to make inferences based on any of the various information available via user-data collection component 210 and user activity monitor 280. For example, inference engine 230 can be used to provide semantic understanding to events and routines, identify previous routines for events, when available, identify events and routines from user data, determine patterns for routines formed by user data (e.g., formed by events), determine event planning activity, determine whether an event is a planned or unplanned deviation from a routine, create and/or update routine and/or event models, determine the importance of individual routines and/or events, determine characteristics of routines and/or events, identify user planning activity, correlate events with routines, and determine events and routine context. These functionalities may utilize various pattern information from inference engine 230, which will later be described in further detail.

Presentation component 220 facilitates the application of routine models, including information derived therefrom, to computer applications, computer services, computer routines, and the like. This can include selecting, determining, generating, and/or presenting content to users based on associated routines and events.

User-data collection component 210 is generally responsible for accessing or receiving (and in some cases also identifying) user data from one or more data sources, such as data sources 104a and 104b through 104n of FIG. 1. In some embodiments, user-data collection component 210 may be employed to facilitate the accumulation of user data of a particular user (or in some cases, a plurality of users including crowd-sourced data) for user activity monitor 280 and inference engine 230.

The data may be received (or accessed), and optionally accumulated, reformatted and/or combined, by user-data collection component 210 and stored in one or more data stores such as storage 225, where it may be made available to other components of routine management system 200. For example, the user data may be stored in or associated with user profile 250, as described herein. In various embodiments, any personally identifying data (i.e. user data that specifically identifies particular users) is either not uploaded from the one or more data sources with user data, is not permanently stored, and/or is not made available to user activity monitor 280 and inference engine 230. Further it is contemplated that any features related to user-data collection and retention be optional and at the discretion of individual users.

User data may be received from a variety of sources where the data may be available in a variety of formats. For example, in some embodiments, user data received via user-data collection component 210 may be determined via one or more sensors (such as sensors 103a and 107 of FIG. 1), which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both.

By way of example and not limitation, user data may include data that is sensed or determined from one or more sensors (referred to herein as sensor data), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user data associated with communication events; etc.) including user activity that occurs over more than one user device, user history, session logs, application data, contacts data, calendar and schedule data, notification data, social network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personalization-related (e.g., “personal assistant”) application or service, home-sensor data, data from a discrete or physical sensor, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, cellular network, or IP address data), and nearly any other source of data that may be sensed or determined as described herein.

In some embodiments, user data may be provided in at least one user-data stream or “user signal,” which can be a feed or stream of user data from a data source. For instance, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user-data collection component 210 receives or accesses the data continuously, periodically, or as needed.

User data, particularly in the form of event data and/or location data can be received by user-data collection component 210 from one or more sensors and/or computing devices associated with a user. While it is contemplated that the user data is processed, by the sensors or other components not shown, for interpretability by user-data collection component 210, embodiments described herein do not limit the user data to processed data and may include raw data.

User activity monitor 280 is generally responsible for monitoring user data or information that may be used for identifying and/or managing routines and events on behalf of one or more users. This information can be used to identify, determine, generate, collect, and/or maintain routines, events, contextual features, and/or personal features, that correspond to user activity associated with one or more users. Any combination of this data may be stored by user activity monitor 280 as user account(s)/activity data in association with users, such as in routine tracking data 253. These includes features (sometimes referred to herein as “variables,” such as routine or event features or variables) or other information relating to routines and events that are identified and/or tracked by user activity monitor 280 with respect to one or more users.

As an overview, event detector 281 detects events, such as events that may be associated with routines, from user activity. Planning activity identifier 285 determines and/or identifies user activity associated with a user planning one or more events. Personal feature identifier 286 is responsible for identifying and optionally determining user features (or variables) associated with a user that may be used for identifying or interpreting patterns (e.g., of events or routines) and other information corresponding to the user. Any of these various components can employ contextual information extracted by contextual information extractor 284 from user data, event-related entities, and/or detected events.

Embodiments of user activity monitor 280 may determine, from the monitored user data, user activity associated with a particular user. As described previously, the user activity information determined by user activity monitor 280 may include user activity information from multiple user devices associated with the user and/or from cloud-based services associated with the user (such as email, calendars, social-media, or similar information sources). User activity monitor 280 may determine current or near-real-time user activity information and may also determine historical user activity information, in some embodiments, which may be determined based on gathering observations of user activity over time, accessing user logs of past activity (such as browsing history, for example), which may be stored in routine tracking data 253 in user profile 250. Further, in some embodiments, user activity monitor 280 may determine user activity (which may include historical activity) from other similar users (i.e., crowdsourcing), as described previously. For example, user data from other users co-located with the user during an event may be analyzed to determine event features.

In some embodiments, information determined by user activity monitor 280 may be provided to inference engine 230 including information regarding events, contextual features of those events, and historical features (historical observations, which may be provided from records in user profile 250).

As indicated above, in some embodiments, the user data and/or information about user activity determined from user activity monitor 280, including event-related information, is stored in a user profile, such as user profile 250. This can include routine tracking data 253 extracted by planning activity identifier 285, personal feature identifier 286, event detector 281, planning activity identifier 285, and/or contextual information extractor 284.

In an embodiment, user activity monitor 280 comprises one or more applications or services that analyze information detected via one or more user devices used by the user and/or cloud-based services associated with the user, to determine project-related activity information and related contextual information. Information about user devices associated with a user may be determined from the user data made available via user-data collection component 210, and may be provided to user activity monitor 280, inference engine 230, routine manager 290, or other components of routine management system 200. More specifically, in some implementations of user activity monitor 280, a user device may be identified by detecting and analyzing characteristics of the user device, such as device hardware, software such as operating system (OS), network-related characteristics, user accounts accessed via the device, and similar characteristics. For example, information about a user device may be determined using functionality of many operating systems to provide information about the hardware, OS version, network connection information, installed application, or the like.

User activity monitor 280 may, at least partially, operate to detect user profile activity that is related to events associated with one or more users. Some embodiments of user activity monitor 280, or its subcomponents, may determine a device name or identification (device ID) for each device associated with a user profile. This information about the identified user devices associated with a user profile may be stored in a user profile associated with the user profile, such as in identifying information 251 of user profile 250. In an embodiment, the user devices may be polled, interrogated, or otherwise analyzed to determine information about the devices. This information may be used for determining a label or identification of the device (e.g. a device ID) so that the user profile interaction with the device may be recognized from user profile data by user activity monitor 280. In some embodiments, user profiles may declare or register a device, such as by logging into an account via the device, installing an application on the device, connecting to an online service that interrogates the device, or otherwise providing information about the device to an application or service. In some embodiments devices that sign into an account associated with the user profile, such as a Microsoft® account or Net Passport, email account, social network, or the like, are identified and determined to be associated with the user profile. Information in one or more of these accounts may provide project entities or user data user activity monitor 280 may use to infer project entities, such as meetings.

In some embodiments, user activity monitor 280, one or more of its subcomponents, routine manager 290, or other components of routine management system 200, such as inference engine 230, may determine interpretive data from received user data. Interpretive data corresponds to data utilized by the components of routine management system 200 or subcomponents of user activity monitor 280 to interpret user data. For example, interpretive data can be used to provide other context to raw user data, which can support determinations or inferences made by the components or subcomponents (e.g., to infer user activity, events, contextual or personal features, and the like). Moreover, it is contemplated that embodiments of user activity monitor 280, its subcomponents, and other components of routine management system 200 may use user data and/or user data in combination with interpretive data for carrying out the objectives of the subcomponents described herein. Additionally, although several examples of how user activity monitor 280 and its subcomponents may identify user profile activity information are described herein, many variations of user profile activity identification and user profile activity monitoring are possible in various embodiments of the disclosure.

As an overview of user activity monitor 280, contextual information extractor 284 is responsible for determining contextual information related to the user profile activity, personal feature identifier 286 is responsible for identifying and optionally determining user features (or variables) associated with a user that may be used for identifying or interpreting patterns and other information corresponding to the user, event detector 281 is configured to detecting and/or identify events from user activity data, and planning activity identifier 285 is configured to determine and/or identify user activity associated with the user planning one or more events.

As mentioned above, contextual information extractor 284, in general, is responsible for determining contextual information related to the user profile activity (detected by user activity monitor 280), such as context, features or variables associated with routine and/or events (e.g., detected keywords), related information, other user-related activity, and further responsible for associating the determined contextual information with the related events and/or routines. In some embodiments, contextual information extractor 284 may associate the determined contextual information with a related event or routine and may also log the contextual information with the associated event or routine. Alternatively, the association or logging may be carried out by another service. For example, some embodiments of contextual information extractor 284 provide the determined contextual information to planning activity identifier 285, which can use the information to determine whether user activity corresponds to event planning activity, personal feature identifier 286, which can use the information to determine user personal features for the user profile, and event detector 281, which can use the information to identify events.

Some embodiments of contextual information extractor 284 determine contextual information in relation to events (e.g., people or contacts present during a meeting and/or event or invited to a meeting and/or event, such as recipients of a group email, invite, or scheduled meeting, related to the event) or the location or venue wherein the event took place, is taking place, or will take place or is to take place. By way of example and not limitation, this may include contextual features such as location data; which may be represented as a location stamp associated with an event; contextual information about the location, such as venue information (e.g., this is the user's office location, home location, conference room, library, school, restaurant, move theater, etc.) time, day, and/or date, which may be represented as a timestamp associated with the event and which, in some embodiments, may include yellow pages identifier (YPID) information; duration of the event, which may be different than a scheduled duration (i.e., the event was longer or shorter than scheduled); other user events or activities preceding and/or following the event, other information about the event such as entities associated with the event (e.g. venues, participants, contacts, people, objects, etc. which may be invited, in attendance, involved in planning, or otherwise involved), information detected by sensor(s) on user devices associated with the user that is concurrent or substantially concurrent to the event (e.g. location, motion information, online activity, user-device interactions, or physiological information detected on a fitness tracking user device), or any other information related to the event that is detectable that may be used for determining patterns of user-related activity associated with events and routines related to the user.

In embodiments using contextual information related to user devices, a user device may be identified by detecting and analyzing characteristics of the user device, such as device hardware, software such as operating system (OS), network-related characteristics, user accounts accessed via the device (e.g., online calendars), and similar characteristics. For example, as described previously, information about a user device may be determined using functionality of many operating systems to provide information about the hardware, OS version, network connection information, installed application, or the like. In some embodiments, a device name or identification (device ID) may be determined for each device associated with a user profile. This information about the identified user devices associated with a user profile may be stored in a user profile associated with the user profile, such as in identifying information 251 of user profile 250.

In an embodiment, the user devices may be polled, interrogated, or otherwise analyzed to determine contextual information about the devices. In some implementations, contextual information extractor 284 may receive user data from user-data collection component 210, parse the data, in some instances, and identify and extract contextual features or variables from the data. Contextual variables may be stored as a related set of contextual information associated with an event (e.g., a meeting event) and/or routine, and may be stored in a user profile such as in routine tracking data 253.

Personal feature identifier 286 is generally responsible for identifying and optionally determining personal features (or variables) associated with the user that may be used for identifying or interpreting patterns and other information corresponding to the user. Personal feature identifier 286 may identify personal features from events, routines, and/or explicit information in user data. These user features may characterize, describe, or define a particular user.

Examples of personal features include information about user(s) using the device; information identifying a user, such as a login password, biometric data, which may be provided by a fitness tracker or biometric scanner; and/or characteristics of the user(s) who use the device, which may be useful for distinguishing users on devices that are shared by more than one user. Other examples, include voice identification information, demographic information, frequented venues or locations, search history, search queries, known interests (e.g., subjects, concepts, topics), organizational title, hierarchy within an organization, and information derived therefrom. One or more of these personal features may be derived from patterns of events and routines analyzed by inference engine 230.

As an example, events can be extracted from user data, as will be described in further detail below, and used to associate the user with one or more routines. When analyzing a particular event, the system can leverage previous semantic knowledge to determine a probability the events are associated with one or more routines. This could include comparing the particular event to information derived from events previously associated with routines. It should be appreciated that this concept may be applied various properties of events including search queries, locations, venues, contacts, etc.

Examples of personal features include information extracted from requests or communications (e.g., entities), such as time/date, scheduled duration, invitees, importance, responses (e.g. acceptance, tentative-acceptance, declines) proposals or suggestions of alternative times/dates/locations/attendees/other entity features, entity subject(s), file attachments or links in entity-related communications, which may include content of the attachments or links, metadata associated with file attachments or links (e.g., author, version number, date, URL or website-related information); whether the entity is recurring (e.g., a meeting); features from related entities or scheduled entities (where the entity is part of a series, such as recurring meetings or events); location-related features, such as location of an event, location of user device(s) during the event (which may indicate whether a user is present, not present, or attending remotely), venue-related information associated with the location, or other location-related information; time related features, such as time(s) of day(s), day of week or month the event, or the duration of the event, or related duration information such as how long the user used an application associated with the event or how long a user traveled to attend the event; user device-related features (which in some embodiments may be used for identifying user attendance (physical or remote), participation, and/or involvement at events), such as device type (e.g. desktop, tablet, mobile phone, fitness tracker, heart rate monitor, etc.) hardware properties or profiles, OS or firmware properties, device IDs or model numbers, network-related information (e.g. mac address, network name, IP address, domain, work group, information about other devices detected on the local network, router information, proxy or VPN information, other network connection information), position/motion/orientation related information about the user device, power information such as battery level, user-access/touch information; usage related features, such as file(s) accessed, app usage (which may also include application data, in-app usage, concurrently running applications), network usage information, online activity (e.g., subject related searches, browsed websites, social networking activity related to the entity, communications sent or received including social media posts, user account(s) accessed or otherwise used (such as device account(s), OS level account(s), or online/cloud-services related account(s) activity, such as Microsoft® account or Net Passport, online storage account(s), email, calendar, or social networking accounts, etc.)), features that may be detected concurrent with the event or near the time or the event, or any other features that may be detected or sensed and used for determining a pattern of routine-related activity for the user. In some embodiments, event logic 295 (described in connection to event detector 281) may be utilized to identify specific features from routine-related information.

Event detector 281, in general, is responsible for determining (or identifying) an event has occurred. As used herein, an event corresponds to one or more defined user activities detectable via one or more computing devices. Some embodiments of event detector 281 may monitor user data for routine-related or event-related features or variables corresponding to user activity such as communications received (e.g., project requests or calendar-related communications), indications of applications launched or accessed, files accessed, modified, copied, etc., websites navigated to, online content downloaded and rendered or played, user location or change of location (e.g. user is located in or has changed locations to a conference room) or similar user activities.

Each event may have a corresponding event definition that comprises one or more conditions and optionally one or more tracked variables. Conditions are utilized by routine manager 290 to determine whether instances of events have occurred and should be detected. In particular, routine manager 290 may detect that an instance of an event has occurred based on determining that the conditions corresponding to the event are met.

Any of a variety of conditions may be placed upon detection of an instance of an event. In some respects, one or more conditions of an event may be satisfied by having user data corresponding to the event available to routine manager 290. As an example, an instance of an event corresponding to a blood pressure reading of a user may be conditioned upon a blood pressure reading being available for a routine of monitoring the blood pressure of the user.

Events may optionally comprise one or more event variables. Event variables comprise data fields that may be populated with data generated from user data by routine manager 290, as provided by user-data collection component 210. Events having one or more event variables may also be referred to as variable events. Other events may be static and can be referred to as static events.

In some cases, conditions of events may employ one or more event variables. For example, one or more conditions of an event may place one or more constraints on values provided by user data for one or more event variables of the event. For example, the event may require that the blood pressure reading is within a designated range for an instance of the event to have occurred.

Tracked variables are event variables that are assigned and/or recorded by routine manager 290 with respect to a corresponding detected instance of an event. In particular, values corresponding to the tracked variables may be stored in association with a user, for example, with respect to a corresponding one of user profiles 250, in routine tracking data 253.

Tracked variables can correspond to any of a variety of user data, examples of which have been described above and include sensor data or readings, which may be sensed by one or more sensors (such as information associated with a user device regarding location, position, motion/orientation, user-access/touch, connecting/disconnecting a charger, user activity on the user device, or other information that may be sensed by one or more sensors, such as sensors found on a mobile device) GPS coordinate samples, and many more. It will be appreciated that values of tracked variables may be associated with one or more events and/or routines and need not be event or routine specific. An example of a tracked variable is a time stamp corresponding to a respective instance of the event. The time stamp can indicate the relative order or sequence of an instance of an event with respect to other instances of the event, and optionally instances of one or more other events of a corresponding routine.

As a further example, an event may comprise a user arriving at a store. One tracked variable may correspond to an arrival location, such as an arrival location name. In detecting the event, routine manager 290 may infer the arrival as being satisfied based on user data comprising GPS data on the user's phone (e.g., user device 102a of FIG. 1), wherein the arrival location name is identified as a store and stored based on interpretive data that includes map data used to associate coordinates from the user's phone with a corresponding location name. Thus, for one instance, the arrival location name may be “Walmart,” and for another instance, the arrival location name may be “Target,” as examples. However, it will be appreciated that the level of granularity in the detection and tracking of events can vary. Thus, as an example, an arrival location name need not be a tracked variable. Furthermore, other examples of potential tracked variables, or more generally event variables, include arrival time (e.g., a time stamp), arrival location coordinates, driving speed, gas mileage, vehicle name, and many more.

Additionally, some embodiments of event detector 281 use contextual information extractor 284 to extract from the user data information about events, which may include current activity, historical activity, and/or related information such as contextual information. Alternatively, or in addition, in some embodiments event detector 281 uses contextual information extractor 284 to determine and extract contextual information that is related to one or more events or routines.

Examples of event-related activity information, that can be extracted by contextual information extractor 284 and used by components of user activity monitor 280, such as event detector 281, may include information describing app usage, online activity, searches, calls, usage duration, application data (e.g., project requests, emails, messages, posts, user profile status, notifications), or nearly any other data related to a user that is detectable via one or more user devices or computing devices, including user interactions with the user device, activity related to cloud services associated with the user (e.g., calendar or scheduling services), online account activity (e.g. email and social networks), and social network activity.

As with other components of routine management system 200, the extracted event information determined by event detector 281 may be provided to other subcomponents of user activity monitor 280, inference engine 230, presentation component 220, routine manager 290, or other components of routine management system 200. Further, the extracted event information may be stored in a user profile associated with the user, such as in routine tracking data 253 of user profile 250. In some embodiments, event detector 281 or user activity monitor 280 (or its other sub components) performs conflation on the detected routine-related information. For example, overlapping information may be merged and duplicated or redundant information eliminated.

In some embodiments, the user data may be interpreted to determine an event has occurred. For example, in some embodiments, event detector 281 employs event logic 295, which may include rules, conditions, associations, classification models, or other criteria to identify project-related activity, such as meeting-related activity. For example, in one embodiment, event logic 295 may include comparing event criteria with the user data in order to determine that an event has occurred.

In some embodiments, the identification and/or classifying of events can be based on feature-matching or determining similarity in features, which may be carried out using statistical classification processes Thus, event logic 295 may comprise pattern recognition classifier(s), fuzzy logic, neural network, finite state machine, support vector machine, logistic regression, clustering, or machine learning techniques, similar statistical classification processes or, combinations of these to identify events from user data. Accordingly, event logic 295 can take many different forms depending on the mechanism used to identify an event, and may be stored in storage 225. For example, event logic 295 might include training data used to train a neural network that is used to evaluate user data to determine when an event has occurred. Moreover, event logic 295 may specify types of event features or user activity such as specific user device interaction(s), that are associated with an event, accessing a schedule or calendar, accessing materials associated with a routine (e.g., an agenda or presentation materials in a meeting), composing or responding to a scheduling request communications, acknowledging a notification, navigating to a website, or launching an app. In some embodiments, a series or sequence of user-related activity may be mapped to an event, such that the event may be detected upon determining that the user data indicates the series or sequence of user-related activity has occurred or been carried out by the user.

In some embodiments, event detector 281 runs on or in association with each user device for a user. Event detector 281 may include functionality that polls or analyzes aspects of the user device, which may include online- or cloud-services accessible via the user device, to determine project-related features, such as sensor output, applications running (and in some instances the content of the applications), network communications, online/cloud activity related to the user, and/or other user actions detectable via the user device including sequences of actions.

In some cases, event detector 281 identifies an event based on determining the event occurred or will occur, which may be based on a confidence score or other metric evaluating whether the event occurred or will occur. In other cases, events can be explicit in user data. Example of explicit events include calendar items, such as meetings, and the like. One or more of these events may be correspond to a data object having content explicitly defined or definable by one or more users (e.g., the message body of an email, start and end times of a meeting).

In some cases, event detector 281 identifies events from contextual information or features associated with one or more routines. For example, contextual information associated with user activity involving a meeting may comprise entity information and characteristics such as emails accessed during the meeting, location of the meeting or of the user during the meeting, photos taken during a meeting, users or contacts attending or invited to the meeting, files accessed or created during the meeting, search queries provided during the meeting such as file searches performed during the meeting or web searches performed during the meeting, and the like. Using characteristics of a routine formed by patterns of historical events, event detector 281 may determine this activity corresponds to a routine-related event.

In various implementations, event detector 281 identifies events in association with one or more email applications. This can be from information (e.g., entities) generated or accessed by an email application or in association with an email application, based on the information being referenced by or to an email application, and/or based on the information being used by or in association with an email application. For example, event detector 281 can analyze emails and/or meeting invites that are sent or received using the enterprise application, attachments to emails or meetings, as well as meetings themselves. Contextual information extractor 284 can be used to extract context for this activity from the various metadata of a meeting invite or other calendar item, such as attachments, titles, subject lines, locations, confirmed participants, invited participants, and the like associated with the user activity. Other sources of information include contacts from the email application and/or from a global contacts list associated with users, which may include a contacts list tracked across user devices and/or integrated into operating system software.

Continuing with routine management system 200 of FIG. 2, inference engine 230 is generally responsible for generating inferences for any of the various components of routine management system 200 such as routine manager 290 and user activity monitor 280. This may include determining patterns based on the various information determined from user activity monitor 280. For example, in some cases, inference engine 230 can be used to determine one or more patterns formed by events and associate the one or more patterns with one or more routines of a user. As a further examples, inference engine 230 may determine routine characteristics 231 or semantic information of routines using one or more patterns formed by the events of the one or more routines. These routine characteristics could be used to determine personal features identified by personal feature identifier 286.

Inference engine 230 may in some cases receive events, event-related entities, contextual information, personal features, user activity data, and/or other user data, at least some of which is provided using user activity monitor 280, or its subcomponents, in order to form inferences.

Routine manager 290 comprises routine identifier 216, out of routine detector 218, planned event determiner 292, and schedule determiner 294. Routine identifier 216 is configured to identify routines of one or more users from user data and/or associate events with routines. In some cases, the identification of routines for users is adaptable, such that a routine identified for a user may no longer be identified for the user in the future based on changes in user behavior over time (e.g., changes in behavior patterns). Out of routine detector 218 is configured to detect or identify divergence between users and their routines. In various implementations, out of routine detector 218 may be utilized to detect or identify events indicating that users will diverge from, are diverging from, or have diverged from one or more routines. In some cases, routines of users may be adapted over time based on changes in user behavior, so as to more accurately detect and identify divergence from those routines (e.g., to adapt to changes in user behavior patterns).

Although routine identifier 216 and out of routine detector 218 are shown as separate components, at least some functionality may be shared between the components. For example, the identification of a routine or event may be implicit in the functionality of out of routine detector 218. As an example, out of routine detector 218 may consider the strength of patterns (indicating routine) formed by detected events in determining whether an out of routine event should be identified. It will therefore be appreciated that not all implementations described herein require both routine identifier 216 and out of routine detector 218.

Routine identifier 216 and out of routine detector 218 may employ accumulated user data and/or interpretive data from one or more data sources, such as any of the various information provided by user activity monitor 280 (e.g., contextual information and personal features) and inference engine 230. Using this information, routine manager 290 can associate events of users with routines, as will later be described in further detail.

Routine manager 290 may optionally identify and track routines and identify out of routine events based on routine models 229 that correspond to the routines. Routine models 229 correspond to representations of corresponding routines. Each routine model comprises one or more events that make up a corresponding routine (e.g., the events routine identifier 216 associates with the routine) and is defined by one or more patterns formed by the events, as later described in further detail.

Routine manager 290 may search and/or analyze user data for any of a variety of events and/or event variables thereof. By matching user data to one or more events and/or event variables thereof, routine manager 290 may detect events and identify routines from patterns of detected events for users, as well as identify and detect potential or actual divergences from events of the routines with respect to the users.

Some examples of how routine identifier 216 may make such determinations are described herein. However, many variations of routine identification and tracking are possible. In some cases, in determining whether a user practices a routine, routine identifier 216 can determine a confidence score of the routine, and/or respective confidence scores of the one or more events of the routine. Where a confidence score of a routine exceeds a threshold value, routine identifier 216 may determine that the user practices the routine. Similarly, where a confidence score of an event exceeds a threshold value, routine identifier 216 may determine that the user practices the event.

A confidence score may correspond to a relative strength of a corresponding modeled pattern appearing in distributions of one or more values of tracked variables of detected events associated with the routine. The confidence score may be impacted by various factors, such as the variance in the patterns, the age of detected events forming the patterns, and the number of detected events forming the patterns. In some cases, where all confidence scores of all events assigned to a routine exceed their respective threshold values, routine identifier 216 may determine that the user practices the routine. It should be noted that any combination of the aforementioned threshold values may be the same or different with respect to one another.

Confidence scores of events and/or routines can be determined by utilizing one or more confidence metrics. In some implementations, confidence metrics increase confidence scores based on detected repetitions or iterations of events and/or routines over time as indicated in patterns formed by the detected events. Confidence scores may be discounted based on lapsed time with respect to one to all of the repetitions or iterations. For example, a confidence score that may have been high in the past may be low in the present based on corresponding user behavior or behaviors having occurred far in the past. As another example, iterations may be phased out from consideration and/or storage over time. In this way, routine identifier 216 can adapt to changing lifestyles in which users may alter their behaviors over time.

As indicated above, any of the various data employed in tracking and identifying routines of users may be stored as routine tracking data 253. In some cases, routine tracking data 253 optionally includes entries that identify routines and assignments between routines and one or more users. The entries may store or otherwise indicate any of the various data associated with a routine, such as events of the routine and/or values associated with tracked variables of those events. Routine tracking data 253 may also comprise confidence scores that correspond to one or more users with respect to events and/or routines. As indicated above, over time, routine manager 290 may update routine tracking data 253 as user data is periodically analyzed and confidence scores are determined and/or updated.

Out of routine detector 218 may utilize routine tracking data 253 to detect or identify that a user is out of routine based on determining that the user will diverge from, is diverging from, or has diverged from one or more routines of the user. In this respect, out of routine detector 218 may identify one or more out of routine events. In some cases, an event may be out of routine for a routine where it is determined that a user will diverge from, or has diverged from, the event with respect to the routine. In this regard, a divergence can correspond to a departure from a modeled pattern of detected events for the routine. Patterns may be modeled using statistical models, such as parametric models, or other suitable models, and may be analyzed to identify divergences therefrom.

It will be appreciated that in some cases, an event may be identified as out of routine based on an actual divergence from the event where user data indicates that the user has already violated some condition or pattern of the routine, as opposed to a predicted divergence from the event where user data indicates that the user is likely to violate some condition or pattern of the routine. An example of an out of routine event may be a user performing one or more user actions (e.g., events) at a time when they usually don't perform that action. In some cases, the user may make a phone call at a time when they usually don't make phone calls. In others, the user may send an email late at night when the user typically does not send emails. However, events need not be identified as out of routine based on temporal divergences. An example is identifying an out of routine event based on a child (i.e., user) communicating with a person they usually do not communicate with online. Another example is identifying an out of routine event based on a child (i.e., user) visiting a web site the child typically does not visit. Yet another example is identifying an out of routine event based on unusual patterns (e.g., erratic behavior) in a user's driving behavior (e.g., as indicated by one or more gyroscopes, accelerometers, and/or other sensor data in the vehicle the user is driving and/or the user's cellular phone). A further example would be a user planning a vacation over a period in which they are usually working (e.g., out of work-related routines).

Thus, it will be appreciated that an event may be identified as out of routine based on a prediction of divergence from the routine. In this way, identification of out of routine events can be forward looking. A prediction of a divergence may be based on interpretive data, detected events, and one or more inferences as to future user actions or events. As an example, a user may usually go to the park every Tuesday but out of routine detector 218 may predict that the user may not walk in the park next (i.e., participate in this routine event) Tuesday based on a weather forecast indicating a high chance for rain on Tuesday. Another example is where the user is identified or detected at the park on a Monday and out of routine detector 218 predicts that the user may not visit the park the following Tuesday because the user's pattern indicates that the user typically visits or walks in the park only once per week.

An example of an actual divergence from an event is a user missing a meeting the user typically attends every Wednesday. An example of a predicted divergence is a prediction that the user will miss the meeting prior to detecting that the user has actually missed the meeting. For example, out of routine detector 218 may infer that the user will miss the meeting based on determining that the user will be on vacation and out of town during the meeting. The determination may be based on one or more detected events and/or user data, such as calendar scheduling data.

An event may be identified as out of routine based on determining that a user has not, will not, or may not satisfy a predicted instance of the event of the routine. For example, out of routine detector 218 may analyze historical detected events for patterns in values of one or more tracked variables, so as to predict value ranges of one or more of the tracked variables to define the predicted instance of the event. Where it is determined that a user has not, will not, or may not satisfy the predicted value ranges, an out of routine event may be detected. As an example, out or routine detector 218 may analyze a distribution of times (e.g., using time stamp values) a user has gone out to lunch in the past and predict that a user will go to lunch between 12:00 PM and 1:00 PM. Based on detected events that indicate the user has not left since arriving at work, after 1:00 PM, out of routine detector 218 may identify the event as out of routine, based on an actual divergence. As another example, based on detected events that indicate the user has scheduled a lunch meeting for the day at 11:30 AM, out of routine detector 218 may identify the event as out of routine, based on a predicted divergence.

As indicated above, patterns of detected events may be employed in identifying that routines correspond to users and/or in detecting divergence from the routines. For example, out of routine detector 218 may detect an out of routine event based upon detecting a divergence from a modeled pattern of one or more tracked variables of the event of the routine.

Exemplary approaches are described below, where each instance of an event has corresponding historical values of tracked variables that form patterns and routine manager 290 may evaluate the distribution of the tracked variables for patterns. In the following example, a tracked variable for an event is a time stamp corresponding to an instance of the event. However, it will be appreciated that, conceptually, the following can be applied to different types of historical values.

A bag of time stamps (i.e., values of a given tracked variable) can be denoted as {tₘ}ₘ₌₁^{M}, and mapped to a two-dimensional histogram of hours and days of the week. The two-dimensional histogram can comprise a summation over the instances of the event, such as:

hᵢⱼ=Σₘ₌₁^{M}I[dayOfWeek[tₘ]=i]∧I[hourOfDay[tₘ]=j].

This histogram can be used to determine derivative histograms. For example, a day of the week histogram may correspond to:

hⱼ=Σᵢhᵢⱼ.

An hour of the day histogram may correspond to:

hᵢ=Σⱼhᵢⱼ.

As further examples, one or more histograms may be determined for particular semantic time resolutions in the form of:

h_{iC}=Σ_{j∈c}hᵢⱼ.

Any of various semantic time resolutions may be employed, such as weekdays and weekends, or morning, afternoon, and night. An example of the latter is where C∈{morning, afternoon, night}, morning={9, 10, 11}, afternoon={12, 13, 14, 15, 16}, and night={21, 22, 23, 24}.

An additional data structure utilized in representing an event can comprise the number of distinct time stamps in every calendar week that has at least one time stamp therein, which may be represented as:

wᵢ^{j}=∥{m|tₘ is within the i-th j week period}∥.

As an example, w³ can denote the number of distinct time stamps during the 2^{nd} three-week period of available time stamps. N^{(j)} may be utilized to denote the number of j-week time stamps available in the tracked data, for example, N⁽³⁾ denotes the number of three-week periods available in the time stamps.

Routine manager 290 may generate a confidence score that quantifies a level of certainty that a particular pattern is formed by the historical values in the tracked variable. In the following example, the above principles are applied utilizing Bayesian statistics.

In some implementations, a confidence score can be generated for a corresponding tracked variable that is indexed by a temporal interval of varying resolution. For time stamps, examples include Tuesday at 9 AM, a weekday morning, and a Wednesday afternoon. The confidence score may be computed by applying a Dirchlet-multinomial model and computing the posterior predictive distribution of each period histogram. In doing so, a prediction for each bin in a particular histogram may be given by:

$${x}_{i} = \frac{{α}_{0} + {h}_{i}}{{\sum }_{i}^{K} ( {α}_{0} + {h}_{i} )} .$$

Where K denotes the number of bins, α₀ is a parameter encoding the strength of prior knowledge, and i*=arg maxᵢ xᵢ. Then, the pattern prediction is the bin of the histogram corresponding to i* and its confidence is given by xᵢ*. As an example, consider a histogram in which morning=3, afternoon=4, and evening=3. Using α₀=10, the pattern prediction is afternoon, and the confidence score is

$$\frac{10 + 4}{( 10 + 3 ) + ( 10 + 4 ) + ( 10 + 3 )} = \frac{14}{40} \approx 0.35 .$$

In accordance with various implementations, more observations results in an increased confidence score, indicating an increased confidence in the prediction. As an example, consider a histogram in which morning=3000, afternoon=4000, and evening=3000. Using a similar calculation, the confidence score is

$$\frac{4010}{10030} \approx 0.4 .$$

Also, in some implementations, a confidence score can be generated for a corresponding tracked variable that is indexed by a period and a number of time stamps. Examples include 1 visit per week, and 3 visits every 2 weeks. Using a Gaussian posterior, a confidence score may be generated for a pattern for every period resolution, denoted as j. This may be accomplished by employing the formula:

$$= λ ( \frac{1}{{N}^{( j )}} {\sum }_{i}^{{N}^{( j )}} {w}_{i}^{( j )} ) + ( 1 - λ ) {μ}_{0} , where λ = \frac{{σ}_{0}^{2}}{\frac{{σ}^{2}}{{N}^{( j )}} + {σ}_{0}^{2}} .$$

In the foregoing, σ² is the sample variance, and σ₀² and μ₀ are parameters to the formula. A confidence score can be computed by taking a fixed interval around the number of time stamps prediction and computing the cumulative density as:

$${conf}_{j} = P ( \vert x - \vert < a ) = 𝒩 ( x \vert , {\hat{σ}}^{( j )} ) , where$$

$${\hat{σ}}^{( j )} = \frac{1}{\frac{{N}^{( j )}}{{σ}^{2}} + \frac{1}{{σ}_{0}^{2}}} .$$

As an example, consider the following observations: w₁⁽¹⁾=10, w₂⁽¹⁾=1, w₃⁽¹⁾=10, w₄⁽¹⁾=0, w₁⁽²⁾=11, and w₂⁽²⁾=10. N⁽¹⁾=4 and N⁽²⁾=2. Using μ₀=1 and σ₀²=10, μ⁽¹⁾=4.075, and conf₁=0.25. Furthermore, μ⁽²⁾=10.31 and conf₂=0.99. In the foregoing example, although fewer time stamps are available for two week periods, the reduced variance in the user signals results in an increased confidence that a pattern exists.

Having determined that a pattern exists, or that the confidence score for a pattern is sufficiently high (e.g., exceeds a threshold value), routine manager 290 may identify that a routine corresponds to a user and/or whether one or more instances or predicted instances of a routine or event diverge from the routine using one or more of these values.

As an example, out of routine detector 218 may determine whether a value of the tracked variable of the routine diverges from or will diverge from that pattern (e.g., based on one or more detected events). For example, out of routine detector 218 may determine that a value of a tracked variable of a predicted instance of a corresponding event of a routine, diverges from or will diverge its expected values. These expected values may be formed by patterns of the historical values of the tracked variable with respect to the routine and represent a characteristic feature of the routine for the user. In some cases, a divergence may be detected where the value is greater than or equal to approximately one standard deviation from the time stamps of the pattern. In some cases, a divergence may be detected where the value is greater than or equal to approximately two standard deviations from the time stamps of the pattern. The standard deviation may be established by mapping a function to the time stamps of the pattern, such as a Gaussian function, or bell curve, as an example.

As a further example, routine identifier 216 may determine that an event of a routine is being practiced by a user (e.g., a detected event is part of or consistent with a routine) where one or more of the confidence scores for one or more tracked variables exceed a threshold value. In this regard, an event of a routine may be determined as being practiced based on routine identifier 216 identifying one or more patterns in historical values of one or more tracked variables of the event.

In tracking routines and events with respect to users, routine manager 290 may employ place prediction, which may be implemented using the histogram model indexed using the temporal interval, as described above. Using the current time, the histogram model may be applied to each of the known places. Each place of these places can yield a probability that estimates a portion of visits to the place at the current time:

$$P ( Place = p \vert time = t ) = \frac{P ( time = t \vert Place = p ) P ( Place = p )}{{\sum }_{{p}^{′}} P ( time = t \vert Place = {p}^{′} ) P ( Place = {p}^{′} )} .$$

Quantity P(time=t|Place=p) is the histogram model described above. P(Place=p) is the prior probability of being in place p. The resolution of time t is relaxed in from narrow to broad (e.g., Tuesday At 9 AM=>Weekday Morning) until the above quantity surpasses a threshold, in which case our model predicts place p.

Further, in tracking routines with respect to users, routine manager 290 may employ next place prediction, which may be implemented using the histogram model indexed by a period and a number of time stamps (i.e., samples), as described above. Using this model, the expectation for a visit in a particular week using the previous number of visits can be computed using the formula:

$$P ( time = t \vert Place = p , Week = w ) = \{ \begin{matrix}P ( time = t \vert Place = p ) & \begin{matrix}( \# of visits for week w - \\ Expected Number Of Visits for week w ) > 0\end{matrix} \\ 0 & otherwise\end{matrix}$$

The expected number of visits per week is computed using the period with the highest confidence.

Distinguishing Out of Routine Events

Approaches have been described above for identifying whether events are associated with routines using routine identifier 216 and detecting out of routine events using out of routine detector 218. Based on these determinations, content may be generated and/or presented to a user using presentation component 220 in order to assist the user with information relevant to the use either being in our out of particular routines.

However, at times, out of routine detector 218 may predict that a user will be out of routine (e.g., engage in an out of routine event or refrain from engaging in an in-routine event), but the user ends up conforming to the routine. This can result in erroneous content being provided to the user. For example, assume out of routine detector 218 predicts a user will be on vacation in Paris in May and prepares content to assist the user on his or her trip. However, shortly before the trip, the user cancels the trip due to an unanticipated work deadline. Without knowledge of the change in plans, significant computing resources could be expended generating and providing the user with erroneous information. Further, the user may not be provided with content to assist in his or her routine-related activities. Implementations of the present disclosure allow for these and other content provision problems to be overcome.

In various implementations, out of routine detector 218 can distinguish between predicted out of routine events that did occur and predicted out of routine events that did not occur. For example, out of routine detector 218 can determine whether user activity conformed with a predicted out of routine event for a routine, or conformed with the routine. Presentation component 220 may generate content, provide content, and/or refrain from the foregoing with respect to the user based on this determination. For example, where it is determined the user conformed to the routine, content may be provided based on the routine. Where it is determined the user conformed to the predicted out of routine event, content may instead be provided based on the predicted out of routine event.

In further respects, when a user is out of routine, that departure from routine may be unplanned or planned by the user. When an unplanned out of routine event occurs, different content may be relevant to the user than when a planned out of routine event occurs. Without the capability of distinguishing between these types of events, erroneous content can be being provided to the user. For example, assume a user plans to miss work and therefore will not practice a work-related event of a routine. Different content would be relevant to this user if instead, the user has to leave or miss work to pick up a sick child.

In various implementations, out of routine detector 218 can distinguish between planned out of routine events and unplanned out of routine events. For example, out of routine detector 218 can determine whether user activity corresponds to planning activity for an out of routine event. When out of routine detector 218 detects an out of routine event occurred or is occurring, the determination can be used to distinguish between whether the out of routine event was planned or unplanned. Presentation component 220 may generate content, provide content, and/or refrain from the foregoing with respect to the user based on this determination. For example, where it is determined the user planned an out of routine event, one set of content may be generated for and/or provided to the user, and where is it determined the user did not plan the out of routine event another set of content may be generated for and/or provided to the user.

In some implementations, out of routine detector 218 determines whether an out of routine event is planned or unplanned based on a user schedule, such as user schedule 254. User schedule 254 represents a schedule of events of the user including planned non-routine events 258 and optionally routine events 256. Out of routine detector 218 can use user schedule 254 to determine whether an out of routine event is planned or unplanned such that appropriate content may be provided to the user. Further, out of routine detector 218 may use the user schedule to determine whether a user conformed to their routine even where a planned or predicted out of routine event indicated otherwise. By constructing a user schedule in advance, these determinations can be made quickly with low processing requirements, which is often essential in providing time critical content to users.

Schedule determiner 294 is generally responsible for constructing user schedules, such as user schedule 254. As indicated above, a user schedule can include predicted events, which may be predicted by routine identifier 216 and/or out of routine detector 218 using approaches described above. Schedule determiner 294 may associate each event in the user schedule with a time, which could correspond to a time stamp, as described above. The time could in some causes be included in a duration of time corresponding to the event, which for routine events may be predicted from durations of past events associated with the routine.

Predicted future events determined in association with one or more user routines may be incorporated into a user schedule. This type of event is also referred to as a routine event, examples of which include routine events 256. Predicted future events determined to be unrelated to one or more user routines and associated with user planning activity may also be incorporated into the user schedule. This type of event is also referred to as a planned non-routine event, examples of which include planned non-routine events 258.

In various implementations, planned event determiner 292 is utilized to determine whether an event is planned or unplanned. Planned event determiner 292 may make these determinations using planning activity identifier 285. As mentioned above, planning activity identifier 285 is configured to determine and/or identify user activity associated with the user planning one or more events. Based on the planning activity, planned event determiner 292 can be used to determine and/or identify planned events. In some cases, out of routine detector 218 uses planned event determiner 292 to predict out of routine events. For example, planned event determiner 292 may generate features corresponding to detected planning activity, which may be used as features in a machine learning model out or routine detector 218 uses to determine out of routine events.

Many suitable approaches exist for identifying and/or detecting planning activity using planning activity identifier 285. In some implementations, one or more planned events are explicitly defined by a user. For example, planned events may be extracted from scheduled meetings, appointments, calendar items, user messages, and the like. Other events may be inferred from detected planning activity and/or known routines of the user. Routine identifier 216 and/or out of routine detector 218 can analyze the various identified events to determine whether they conform with and/or deviate from one or more routines of the user.

In some implementations, planning activity identifier 285 is configured to identify one or more events (or combinations or groups of events) that are pre-associated with planning activity. For example, some of the events detected using event detector 281 or combinations thereof may be known to correspond to planning activity. Therefore, where these types of events are detected, planning activity identifier 285 may identify them as planning activity. In addition or instead, planning activity identifier 285 can analyze detected events (either individual or in groups) to determine whether the events either individually or collectively correspond to planning activity. This may include, for example, analyzing event definitions, tracked variables of events, conditions of events, contextual information of the events, or other user activity data.

Examples of planning activity which may be detected using planning activity identifier 285 include a user making reservations, buying tickets, user driving to a bank, searching the internet using particular topics or visiting particular sites, launching a planning-related application or service, making a phone call, being in a particular geographic region, being at a particular geographic location, attending a meeting, causing a sensor reading from a mobile device, leaving work early, launching a service content item, interacting with a service content item, watching a video, downloading a service content item, and/or any combination thereof, amongst many more possibilities.

In some implementations, planning activity identifier 285 identifies planning activity at least partially from one or more conversations between at least two users, such as a conversation in a hallway, an instant message conversation, a phone conversation, or other conversations which may comprise communications between users. For example, planning activity identifier 285 may analyze one or more communications of a conversation. As an example, user device 102a could capture the user saying to another user: “Let's meet for dinner and Joe's tonight at 6 PM.” Planning activity identifier 285 can use contextual information such as the time and location as indicators of planning activity, resulting in a corresponding planned event in the user schedule. Further, the time, location, and activity may be recorded in association with the planned event. Using the extracted time and activity, out of routine detector 218 may determine the planed event diverges from the user's typical behavior of eating dinner at home on Thursday, resulting in a planned non-routine event being included in the user schedule.

It is noted, a conversation may involve at least two users, but a communication need not be provided or identified from both users in a conversation. Analyzing a conversation can include extracting contextual information (such as keywords) from the communications and/or other information associated with the conversation (e.g., using contextual information extractor 284) and determining whether the contextual information indicates planning activity. Sources of contextual information for a conversation include files, documents, emails, events, calendar events, meetings, contacts, users, word processing documents, meeting participants, image documents, presentation documents, applications, time slots, text such as words or phrases, topics, search queries or history, concepts, keywords, pictures, locations, venues, and more.

A conversation may be analyzed and captured by any suitable digital medium and in some cases is facilitated by one or more digital services, such as applications. For example, one or more digital services may be used to manage and track the exchange of conversational messages (i.e., the messages that comprise the conversation) between users. Examples include instant messaging programs, email programs, chat programs, video chat programs, Voice over Internet protocol (VoIP) programs, text messaging programs, conferencing programs, and more. Examples of the digital mediums include instant messages, emails, streaming or live video, a video file, streaming or live audio, an audio file, VoIP and/or phone transmissions, text messages, recordings, records, or logs of any combination of the forgoing, and more.

A conversation may occur cross-service and/or cross digital medium. For example, the same conversation could include a user texting another user and the other user emailing the user a response. A conversation may be analyzed in real time, as it is occurring (e.g., from streaming data), and/or after it has completed (e.g., from log data). For example, a conversation may be provided from an audio feed of a conversation captured by one or more user devices (e.g., a mobile phone).

Where an event is explicitly scheduled by a user, planning activity identifier 285 may determine the event is a planned event. Furthermore, where an event is part of a routine of the user, planning activity identifier 285 may determine the event is a planned event. Also, where planning activity identifier 285 can identify planning activity associated with an event, planning activity identifier 285 may determine the event is a planned event (e.g., an inferred event which is not part of a routine).

In some implementations, event detector 281 analyzes sensor data associated with a user to determine whether the sensor data corresponds to an event in the user schedule. Characteristic features of routines associated with the events and/or of the events can be loaded, generated, and/or otherwise be made available based on the events in the user schedule as well as the times associated with the events. This can assist in quickly and efficiently identifying the events in real-time. For example, real-time sensor data can be analyzed for contextual information and compared to the characteristic features to determine whether the event is occurring or has occurred (e.g., using a confidence score). Based on identifying the event, content can be generated and/or provided to the user as described above.

It is noted, at least some of the content provided to the user may be generated in advance by presentation component 220 (e.g., in advance of the event occurring) for the user based on whether the event is determined to be out of routine or conform with a routine. Where routine manager 290 determines a planned event did not occur or will not occur, presentation component 220 may refrain from presenting that content to the user. Furthermore, based on routine manager 290 determining an out of routine event for a routine did not occur, presentation component 220 may generate and/or provide content associated with the routine to the user.

As an example, assume an out of routine event corresponds to a planned event involving a user going on vacation, which is out of routine for a routine of going to work (e.g., the vacation is planned for days the user is typically at work). Presentation component 220 may prepare content to assist the user while on vacation in advance. If routine manager 290 determines the user did not or will not go on vacation (e.g., the user missing a planned event corresponding to a flight), presentation component 220 may refrain from presenting content association with the vacation. Therefore, presentation component 220 may instead present content associated with the routine which the out of routine event would have deviated from based on this determination. In some cases, the presentation may additionally be based on routine manager 290 determining the user is or will conform to the routine from which the out of routine event deviated. For example, this may be based on determining a routine-related event is occurring or will occur using sensor data.

Content presented using presentation component 220 may be presented, for example, on any combination of user devices 102a and 102b through 102n. In this capacity, presentation component 220 may employ any of the various data stored with respect to user profiles 250, as well as other data. Presentation component 220 can determine when and/or how content is presented to a user. Presentation component 220 can further determine what content is provided to the user. In some embodiments, presentation component 220 comprises one or more applications or services operating on a computing device (such as computing device 800 described in FIG. 8 including a user device, such as a mobile computing device) or in the cloud.

Determinations made by presentation component 220 with respect to content to be presented based user routines and events may optionally be based on contextual information corresponding to the events or routine. In some implementations, routine manager 290 may generate the contextual information, which may be provided to presentation component 220. The contextual information generally corresponds to information that provides context to a detected event.

Routine manager 290 may generate contextual information utilizing interpretive data to infer or otherwise determine the contextual information, at least partially, from user data associated with the user. For example, contextual information could indicate that a user is out of town if the user is located in a different country than their residence. Other interpretive data could be used to further distinguish whether the user is on a personal vacation or is on a business trip. As another example, contextual information could indicate whether a detected event is a planned or unplanned event, and/or whether the event is in conformance with or out of routine for the user.

Routine manager 290 may also generate contextual information utilizing interpretive data to infer or determine the contextual information, at least partially, from user data associated with at least one other user, such as an aggregate of user data. Contextual information can comprise semantic data corresponding to an identified divergence. Semantic data can supplement user data (e.g., sensor data) that is utilized to identify the divergence, such as semantics of a detected event of a user. Examples of semantic data include the time of day, whether it is a weekend, weekday, or holiday, weather conditions, and many more.

Contextual information may indicate or otherwise correspond to a cause of or reason for a divergence from a routine. In some cases, generating the contextual information comprises categorizing a divergence from a routine. In particular, routine manager 290 may assign one or more predetermined categories to the divergence. As one example, a divergence may be categorized as either planned or unplanned. In some cases, an assigned category may correspond to a categorization of a cause of or reason for the divergence. The assignment may optionally be based on an analysis of the user data (e.g., aggregated user data and/or user data corresponding to the user) and/or interpretive data.

In some cases, generating the contextual information comprises assigning one or more user-specific categories, or categories that are specific to a user (i.e., user-specific), to the divergence. Furthermore, generating the contextual information can comprise assigning one or more user-general categories, or categories that are general to the user (i.e., user-general, or non-specific to the user), to the divergence. A cause that is specific to a user may be personal to the user. For example, a user may have missed an event of going to work because the user was sick. A cause that is general to a user may be shared between multiple users. For example, multiple users may have missed an instance of an event due to a national holiday.

In some cases, routine manager 290 may determine whether a cause is user-specific or user-general by analyzing the divergence with respect to divergences of one or more other users. For example, routine manager 290 may determine that the cause is not shared between multiple users with respect to the same or different corresponding event(s) and/or routine(s). Where a cause is shared by one or more users, routine manager 290 may determine that the cause is general to the user. As an example, routine manager 290 may make the determination based on a number of other user's diverging from the same event(s) and/or routine(s). If many other users are diverging from the same event(s) and/or routine(s), it may be more likely that a cause of a given user's divergence is general to the user. Thus, a cause may be categorized as user-general based at least in part on the number of other users exceeding a threshold value.

In determining whether a cause is user-specific or user-general, or otherwise generating contextual information and/or categorizations for a divergence of a user from a routine, other users may be considered based on one or more identified similarities to the user (i.e., a subset of users). For example, routine manager 290 may select, or group, users by one or more shared characteristics. One example of a shared characteristic is a shared geographical region. For example, each user may be considered by routine manager 290 based on being from the same city, state, country, or continent as the user. As another example, a shared characteristic may comprise shared demographic information. Examples include a shared gender, age, age range, income level, race, and/or ethnicity.

Routine manager 290 may identify one or more shared characteristics from data associated with one or more of user profiles 250, such as profile data of multiple users. In addition, or instead, a shared characteristic may be based on one or more values of one or more tracked variables of one or more events. For example, a tracked variable could be a blood sugar level of a user. Routine manager 290 may select users based on identified similarities in blood sugar levels. The similarities may be on the aggregate for data accumulated with respect to the users (e.g., an average value over all accumulated values), or could be based on one or more particular instances, or groups of instances, such as one or more instances associated with a divergence.

Other examples of contextual information are confidence scores, variance scores, and other information generated in identifying an out of routine time. A further example is an importance level of the identified out of routine event. For example, the importance level could increase with a number of times an out of routine event is detected for an event. When the importance level is low, no action may be required in response to identifying an out of routine event. Furthermore, different actions may be taken, or may be recommended to be taken, for different importance levels. Importance levels could also factor in identified out of routine events for one or more other events and/or routines. For example, the importance level could increase for each identified out of routine event over a period of time.

In some cases, presentation component 220 may provide content to a user based on an identified divergence from a routine and/or contextual information corresponding to the divergence. For example, if contextual information indicates that the user is on vacation in Scotland, the content provided to the user may provide information about the country, leisure activities available in the area, and the like. This content would not be presented, for example, if the contextual information indicated the user was in Canada, or at work. Where contextual information comprises one or more categories, at least some of the content provided to the user may be associated (e.g., pre-associated) with a category assigned to the identified divergence. Thus, different categories may have at least some different associated content for presentation, and the content that is provided to the user may depend upon which category or categories have been assigned to the identified divergence.

In some cases, content may be provided to the user that is not provided to the user when the user is in conformance with each event of a routine. The content may be new content that is generated and/or presented based on the identifying of the divergence. For example, assume that Ben is in the routine of going out for lunch each day around 1 PM. Routine manager 290 may determine that Ben has diverged from a routine based on detecting that Ben has not left his office as of 3 PM. Based on the detected divergence, content is presented to Ben suggesting that Ben order food, which would not have been presented to Ben but for the divergence being identified. The content may comprise generated content (e.g., generated based on the identifying) comprising one or more specific restaurants, such as fast food restaurants. At least some of the content may be relevant to the out of routine event (e.g., contextual information of the out of routine event) but would not be relevant to the user's tracked pattern of events. For example, a recommended restaurant may not open until 3 PM, and therefore would not be relevant if it were recommended for Ben's typical 1 PM lunch based on patterns of tracked detected events.

In an embodiment the content comprises one or more suggestions, recommendations, or relevant information based on the detected divergence. For example, in one embodiment, upon determining that a user did not arrive at his office by a certain time (e.g., 10:00 AM) in the morning but instead stayed home (e.g., the user is sick), content may be generated including a suggestion that the user send cancellation emails for meetings scheduled that day and/or a prompt asking the user if he would like to automatically reschedule the meetings. Additional content may be generated and provided to the user including a prompt asking if the user would like to schedule an appointment with a doctor, and/or information regarding television programs likely to be of interest to the user.

As another example, using embodiments of the invention it may be determined that a particular user plays golf every Tuesday evening as a routine. Upon determining that a user missed (or is missing, or will miss) her golf game and has thus diverged (or will diverge) from her routine, content may be generated and presented to the user including one or more of (a) a suggestion for scheduling a tee time at a future time, based on the user's schedule, user routine information, information from sources associated with the golf course (such as a website for the golf course), and/or other user information such as calendar information; (b) a prompt asking the user if the user would like make up the missed golf game (missed instance of an event) and/or if the user would like to automatically schedule a game at a future time; (c) additional information that may be relevant to missed golf game or make-up game based on the contextual information, such as green fees on the dates and times of the potential make-up game.

In addition, or instead, presentation component 220 may refrain from presenting content to the user based on an identified divergence from a routine and/or contextual information corresponding to the divergence. For example, content may sometimes be presented based on routine identifier 216 determining a user practices a routine, which may not be presented based on out of routine detector 218 detecting a divergence between the user and the routine. The content may have otherwise been presented absent the identification of the out of routine event but is no longer relevant, and thus not presented, due to the divergence. For example, presentation component 220 may typically present the content to the user based on an indication that the user practices the routine (e.g., from routine identifier 216) without an indication of an identified out of routine event.

To illustrate the foregoing, in the above example, based on identifying the routine of Ben, presentation component 220 may typically present content to Ben comprising a recommended place for Ben to eat, on a periodic basis, such as each day before his lunch at 1 PM (e.g., corresponding to a predicted instance of an event and/or routine). However, based on out of routine detector 218 determining that Ben ate lunch at 12 PM, presentation component 220 may refrain from presenting the content corresponding to the recommendation.

Where presentation component 220 refrains from presenting content to a user, processing, power, and other resources related to the presentation of the content are conserved. Furthermore, in cases where refraining from presenting the content to the user includes refraining from generating at least some of the content based on an identified divergence from a routine and/or contextual information corresponding to the divergence, resources are further conserved. For example, generating content may utilize network bandwidth, processing power, and energy.

Furthermore, presentation component 220 may modify content presented to the user, or the presentation thereof, based on an identified divergence from a routine and/or contextual information corresponding to the divergence. The content may correspond to content that is typically presented when a user is practicing a routine, and is not detected as diverging from their routine. Examples of modifying content include redacting content, replacing content, changing content, substituting content, and adding to content.

In the example above, the recommendation of the restaurant is an example of such content. An example of a modification of the content would be where the restaurant that is recommended is based on the diverging from the routine. For example, a restaurant may still be recommended to Ben, based on detecting that Ben has diverged from his routine by not having eaten lunch by 2 PM.

However, the restaurant (i.e., content) that is recommended may be based on identification of the divergence, such that it may be different than the restaurant recommended prior to 1 PM. As an example, presentation component 220 may perform restaurant (i.e., content) selection by selecting a restaurant from one or more other selectable restaurants (i.e., selectable content). The selecting may evaluate the restaurants with respect to one or more criteria. The outcome of the evaluation may be different based on the identification of a divergence from a routine. For example, contextual information and/or values of tracked variables associated with the divergence may result in a different restaurant being selected based on the divergence. As an example, the selection of the restaurant may be conditioned upon the restaurant still serving lunch at 2 PM, whereas the restaurant recommended prior to 1 PM no longer serves lunch at 2 PM.

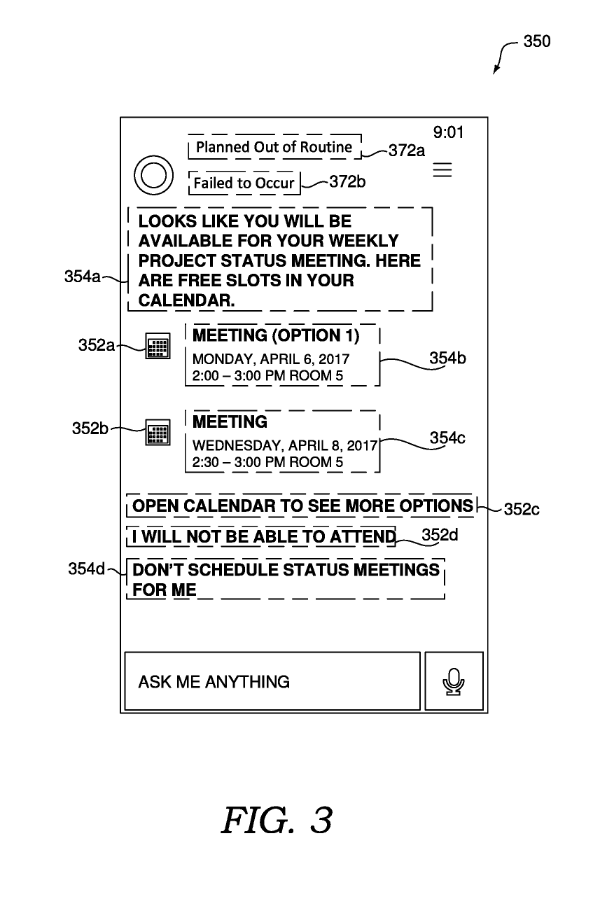

In some implementations, the content presented to a user is determined using one or more content templates, or content cards. Populated exemplary content card 350 is shown in FIG. 3. A content card can comprise one or more static content fields and/or one or more dynamic content fields. Examples of static content fields include static content fields 352a, 352b, 352c, and 352d in FIG. 3. Examples of dynamic content fields include dynamic content fields 354a, 354b, 354c, and 354d. Static content fields correspond to content fields having corresponding content that is displayed each time the content card is presented. Dynamic content fields correspond to content fields having corresponding content that may vary between presentations of the content card.

In some cases, presentation component 220 may provide content to a user based on an identified divergence from a routine and/or determining the user will conform to the routine from which the divergence was identified, such as using content card 350. For example, presentation component 220 may select one or more content cards based on identifying the divergence and/or the routine, and/or modify one or more dynamic content fields of the selected content cards based on identifying the divergence and/or based on the routine. Thus, for example, corresponding content of one or more dynamic content fields may be modified for presentation, removed from presentation, or otherwise determined. Furthermore, one or more content cards may be modified for presentation, removed from presentation, refrained from or removed from being presented, or otherwise be selected for presentation using these determinations.

Thus, content card 350 may correspond to a presentation of content card 350 based on an identified divergence from a routine and/or contextual information corresponding to the divergence. In addition or instead, content card 350 may correspond to determining conformance to the routine and include at least some information that is typically presented to the user when the user is not determined to be diverging from the routine.

In some implementations, content card 350 includes one or more explanatory indicators, such as explanatory indicators 372a and 372b, which each indicate a cause or explanation of the content being provided to the user. Examples of an explanatory indicator includes an icon, text string, image, audio clip, and the like, which may be presented with or separate from the corresponding content. In the present example, explanatory indicators 372a and 372b each comprise a textual explanation which varies based on one or more causes of the content being provided to the user. For example, explanatory indicator 372a corresponds to a trigger activity type or category for the content and indicates the trigger activity type is a planned divergence from a routine of the user. As another example, an explanatory indicator could correspond to a trigger activity type or category for the content and indicate the trigger activity type is an unplanned divergence from a routine of the user. As a further example, an explanatory indicator could correspond to a trigger activity type or category for the content and indicate the trigger activity type is an inferred routine of the user.

Explanatory indicators 372b can indicate, for example, a trigger event type of the present of the content to the user. For example, explanatory indicator 372b corresponds to a trigger event type or category for the content and indicates the trigger event type is a failure of a planned divergence from a routine. As another example, an explanatory indicator could correspond to a trigger event type or category for the content and indicate the trigger event type is conformance with a planned divergence from a routine, conformance with a routine, an unplanned divergence from a routine, and more.

In some cases, instances of presentation component 220 are incorporated into one or more services (e.g., applications, processes, programs, threads, etc.), which may be running on a user device, and/or a different system than any combination of the various constituents of routine management system 200. As an example, one or more services may receive any combination of information generated and/or stored by routine management system 200, which may be incorporated into routine tracking data 253.

Examples include one or more confidence scores, contextual information, recommended actions, tracked variable variance scores, and more. A service could be running on a user device and may receive such information from a server. As another example, the service could be running on a server in a different system than servers providing such information. As a further example, the information could be received from one or more other services running on the same device (e.g., a user device) as the service. For example, one to all of the various components of FIG. 2 could be incorporated into the same device, which in some cases may be beneficial for security, privacy, and/or other reasons.

In some cases, one to all of the information may be pushed to the service from a server, for example, based on a subscription to the information. As another option, one to all of the information could be queried for by the service. As an example, the information could be stored in one or more entries in a database corresponding to routine tracking data 253. The service, such as an application, may query that information for use by presentation component 220.

Thus, it will be appreciated that, in some cases, routine manager 290 and/or other constituents of routine management system 200 may be provided to applications or services as a cloud service. In this regard, applications on user devices may optionally incorporate an application programming interface (API) for communicating with the cloud service and for providing at least some functionality of presentation component 220. In this way, a common framework may be provided to applications for tailoring content to users based on divergences from their routines.

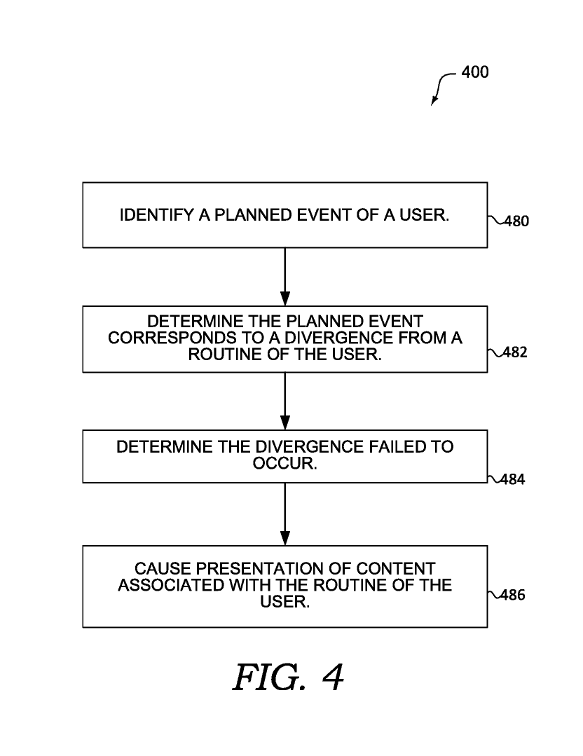

Referring now to FIG. 4, FIG. 4 is a flow diagram showing method 400 for distinguishing events of users in accordance with disclosed embodiments. Each block of method 400 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

At block 480, method 400 includes identifying a planned event of a user. As an example, planned event determiner 292 can identify a planned event of a user using user activity monitor 280.

At block 482, method 400 includes determining the planned event corresponds to a divergence from a routine (e.g., one or more routines corresponds to routine models 229) of the user. For example, out of routine detector 218 can determine the planned event corresponds to a divergence from a pattern of detected instances of a routine of the user based on the user activity data. The routine may have been identified, for example, using routine identifier 216.

At block 484, method 400 includes determining the divergence failed to occur. For example, routine manager 290 may determine the divergence failed to occur using user activity monitor 280.

At block 486, method 400 includes causing presentation of content associated with the routine of the user. For example, presentation component 220 can based on the determining the divergence failed to occur, cause presentation of content associated with the routine on user device 102a. This may include generating the content and/or providing the content to the user device.

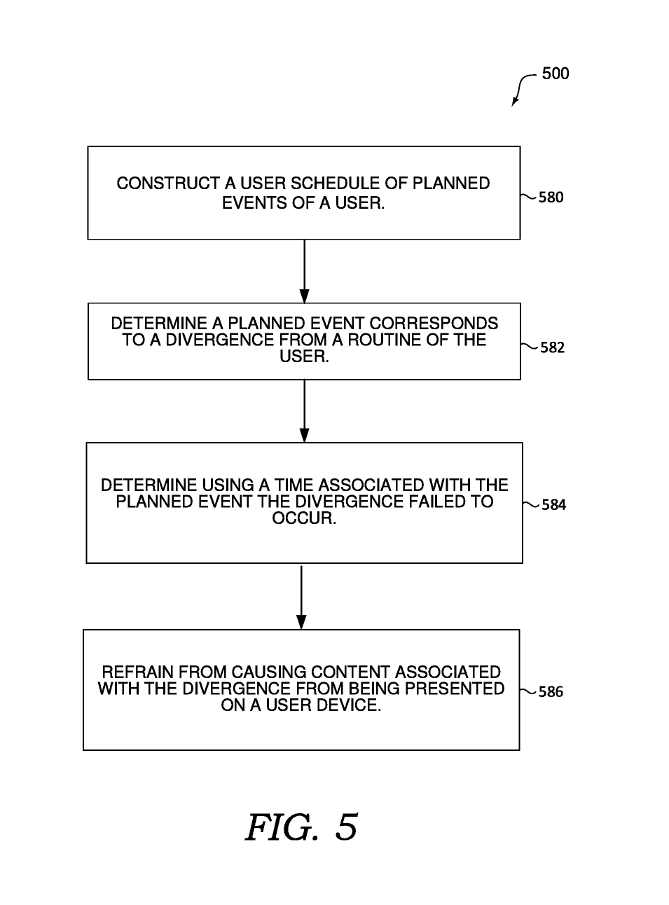

Referring now to FIG. 5, FIG. 5 is a flow diagram showing method 500 for distinguishing events of users in accordance with disclosed embodiments. At block 580, method 500 includes constructing a user schedule of planned events of a user. For example, schedule determiner 294 can construct user schedule 254 comprising planned events of a user, where each planned event is associated with a time.

At block 582, method 500 includes determining a planned event corresponds to a divergence from a routine of the user. For example, out of routine detector 218 can determine at least one planned event of the planned events corresponds to a divergence from a pattern of detected instances of a routine of the user based on user activity data from a set of sensors. Out of routine events detected by out of routine detector 218 may correspond to one or more of planned non-routine events 258. The routine may have been identified, for example, using routine identifier 216.

At block 584, method 500 includes determining using a time associated with the planned event the divergence failed to occur. For example, routine manager 290 can determine, using the time associated with the at least one planned event, the divergence from the routine failed to occur.

At block 586, method 500 includes refraining from causing content associated with the divergence from being presented on a user device. For example, based on the determining the divergence failed to occur, presentation component 220 can refrain from causing content associated with the divergence from the routine to be presented on a user device. Instead, presentation component 220 may cause content associated with the routine to be presented on the user device.

Referring now to FIG. 6, FIG. 6 is a flow diagram showing method 600 for distinguishing events of users in accordance with disclosed embodiments. At block 680, method 600 includes constructing a user schedule of planned events of a user. For example, schedule determiner 294 can construct user schedule 254 comprising planned events of a user.

At block 682, method 600 includes determining a planned event corresponds to a divergence from a routine of the user. For example, out of routine detector 218 can determining at least one planned event of the planned events corresponds to a divergence from a pattern of detected instances of a routine of the user based on user activity data from a set of sensors. Out of routine events detected by out of routine detector 218 may correspond to one or more of planned non-routine events 258. The routine may have been identified, for example, using routine identifier 216.

At block 684, method 600 includes identifying an occurrence of an event of the user. For example, routine identifier 216 may identify an occurrence of an event of the user from user activity data using event detector 281.

At block 686, method 600 includes determining the planned event the divergence failed to occur based on the occurrence of the event and the user schedule. For example, routine manager 290 can determine, determining the divergence failed to occur based on the occurrence of the event and user schedule 254. The event may be an event not in user schedule 254, or may be in user schedule 254, but stored with an indication that it was determined the event would not occur based on the determining the divergence will occur.

At block 688, method 600 includes causing content associated with the routine to be presented on a user device. For example, based on the determining the divergence failed to occur, presentation component 220 can cause content associated with the routine and/or event to be presented on a user device. Presentation component 220 may also refrain from presenting content associated with the divergence to be presented on the user device.

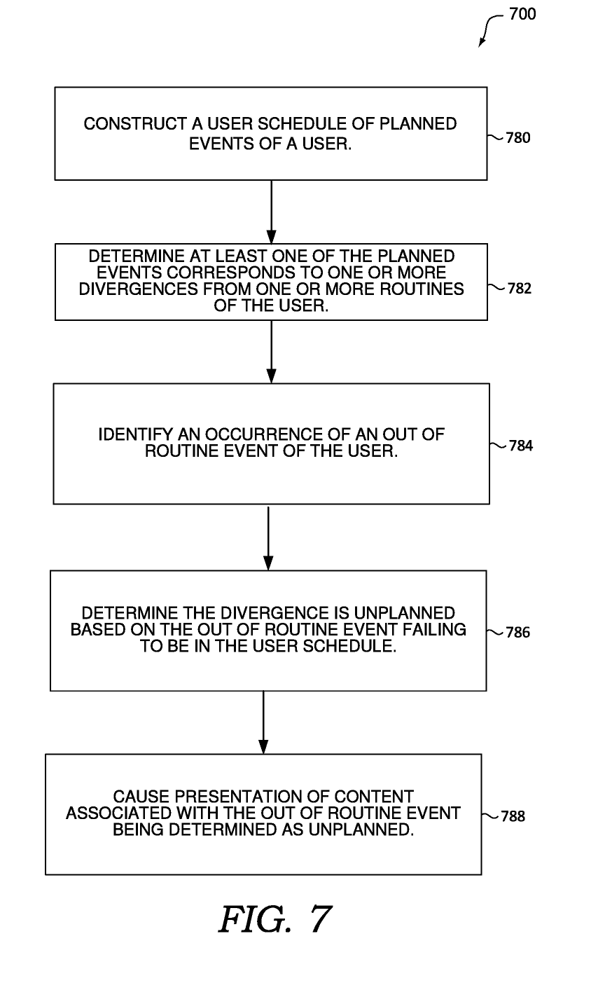

Referring now to FIG. 7, FIG. 7 is a flow diagram showing method 700 for distinguishing events of users in accordance with disclosed embodiments. At block 780, method 700 includes constructing a user schedule of planned events of a user. For example, schedule determiner 294 can construct user schedule 254 comprising planned events of a user.

At block 782, method 700 includes determining at least one of the planned events correspond to one or more divergences from one or more routines of the user. For example, out of routine detector 218 can determine at least one of planned non-routine events 258 corresponds to an out of routine event. The one or more routines may have been identified, for example, using routine identifier 216.

At block 784, method 700 includes identifying an occurrence of an out of routine event of the user. For example, out of routine detector 218 can detect an out of routine event (e.g., from real-time or near real-time user data).

At block 786, method 700 includes determining the divergence is unplanned based on the out of routine event failing to be in the user schedule. For example, routing manager 290 can determine the divergence is unplanned based on the out of routine event failing to correspond to any event in user schedule 254. In addition or instead, this determination could be based on routine manager 290 failing to identify planning activity associated with the out of routine event being determined as unplanned.

At block 788, method 700 includes causing presentation of content associated with the out of routine event being unplanned. For example, presentation component 220 may cause content to be presented on user device 102a based on determining the out of routine event was unplanned. This content may be different than content that would have been presented had routine manager 290 determined the out of routine event was planned.

Having described implementations of the present disclosure, an exemplary operating environment in which embodiments of the present invention may be implemented is described below in order to provide a general context for various aspects of the present disclosure. Referring initially to FIG. 8 in particular, an exemplary operating environment for implementing embodiments of the present invention is shown and designated generally as computing device 800. Computing device 800 is but one example of a suitable computing environment and is not intended to suggest any limitation as to the scope of use or functionality of the invention. Neither should the computing device 800 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including handheld devices, consumer electronics, general-purpose computers, more specialty computing devices, etc. The invention may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 8 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer-storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

As can be understood, implementations of the present disclosure provide for tailoring content to out of routine events. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. A computer-implemented system comprising:
one or more processors; and
one or more computer-readable storage media having instructions stored thereon, wherein the instructions, when executed by the one or more processors, cause the one or more processors to perform a method comprising:
constructing a user schedule comprising planned events of a user;
determining a planned event of the planned events corresponds to a divergence from a pattern of detected instances of a routine of the user based on user activity data from a set of sensors;
identifying an occurrence of an event of the user from the user activity data;
determining the divergence failed to occur based on the occurrence of the event and the user schedule; and
based on the determining the divergence failed to occur, causing content associated with the routine to be presented on a user device.

2. The system of claim 1, wherein the method comprises:
determining the user activity data corresponds to planning activity of the user based on an analysis of at least one user communication of a conversation between users;
identifying the planned event based on the determining the user activity data corresponds to planning activity; and
incorporating the identified planned event into the user schedule.

3. The system of claim 1, wherein the determining the divergence failed to occur is based on the occurrence of the event being after a time associated with the planned event in the user schedule.

4. The system of claim 1, wherein the determining the divergence failed to occur is based on determining the event conforms to the routine of the user.

5. The system of claim 1, wherein the user activity data is determined from location data of a mobile device associated with the user.

6. The system of claim 1, wherein the pattern is formed by time stamps corresponding to the detected instances of the routine.

7. The system of claim 1, comprising refraining from causing content associated with the divergence to be presented on the user device based on the determining the divergence failed to occur.

8. The system of claim 1, comprising:
identifying an additional occurrence of an additional event of the user from the user activity data;
determining the additional event is an unplanned event based on the additional event failing to be in the user schedule; and
causing content associated with the additional event being the unplanned event to be presented on the user device based on the determining the additional event is the unplanned event.

9. The system of claim 1, comprising:
inferring a routine event of a given routine will be practiced by the user based on at least one pattern formed by events of the given routine; and
incorporating the routine event into the user schedule based on the inferring.

10. A computer-implemented method comprising:
identifying a planned event of a user from user activity data from a set of sensors;
determining the planned event corresponds to a divergence from a pattern of detected instances of a routine of the user based on the user activity data;
determining the divergence from the routine failed to occur based on an analysis of the user activity data; and
based on the determining the divergence failed to occur, causing presentation of content associated with the routine on a user device.

11. The method of claim 10, wherein the identifying the planned event is based on determining the user activity data corresponds to planning activity of the user based on an analysis of at least one user communication of a conversation between users.

12. The method of claim 10, wherein the determining the divergence failed to occur is based on a time associated with the planned event.

13. The method of claim 10, wherein the determining the divergence failed to occur is based on identifying an occurrence of a routine event of the routine from the user activity data.

14. The method of claim 10, wherein the user activity data is determined from location data of a mobile device associated with the user.

15. The system of claim 1, comprising incorporating the planned event into a user schedule comprising a plurality of planned events of the user, wherein the determining the divergence from the routine failed to occur is based on the user schedule.

16. One or more computer storage media storing computer-useable instructions that, when used by one or more computing devices, cause the one or more computing devices to perform a method comprising:
constructing a user schedule comprising planned events of a user, each planned event associated with a time;
determining at least one planned event of the planned events corresponds to a divergence from a pattern of detected instances of a routine of the user based on user activity data from a set of sensors;
determining, using the time associated with the at least one planned event, the divergence from the routine failed to occur; and
based on the determining the divergence failed to occur, refraining from causing content associated with the divergence from the routine to be presented on a user device.

17. The one or more computer storage media of claim 16, wherein the method comprises:
determining the user activity data corresponds to planning activity of the user based on an analysis of at least one user communication of a conversation between users;
identifying the at least one planned event based on the determining the user activity data corresponds to planning activity; and
incorporating the identified at least one planned event into the user schedule.

18. The one or more computer storage media of claim 16, wherein the determining the divergence failed to occur is based on an occurrence of a detected event being after the time associated with the at least one planned event.

19. The one or more computer storage media of claim 16, wherein the determining the divergence failed to occur is based on determining a detected event conforms to the routine of the user.

20. The one or more computer storage media of claim 16, comprising causing content associated with the routine to be presented on the user device based on the determining the divergence from the routine failed to occur.
